(19) United States
(12) Patent Application Publication
(10) Pub. No.: US 2018/0068460 A1
(43) Pub. Date: Mar. 8, 2018

(54) Liquid Level Detecting System and Method thereof

(71) Applicant: Taiwan Intelligent Robotic Company, Ltd., Taipei City (TW)

(72) Inventors: Kuo-Tsung Huang, Taipei City (TW); Yu-Chun Chen, Taipei City (TW)

(21) Appl. No.: 15/693,478

(22) Filed: Sep. 1, 2017

(30) Foreign Application Priority Data
Sep. 6, 2016 (TW) 105128723

(51) Int. Cl. G06T 7/60; G01F 23/02; H04N 5/232

(52) U.S. Cl. CPC G06T 7/60; G06T 5/002; H04N 5/23229; G01F 23/02

(57) ABSTRACT

A liquid level detecting system and method thereof are provided in present application. Aforementioned system acquires an image containing transparent container and labeling element, analyzes the image portion of the labeling element which effected by the tested liquid in the transparent container so as to determine the liquid level of the tested liquid. Comparing with the imaging recognition technique for measuring liquid level of prior art, the system and method thereof of present application is able to determine the liquid level of the transparent liquid in transparent container effectively.

### BACKGROUND OF THE INVENTION

This application claims priority benefit of TW Patent Application Ser. No. 105128723 filed 2016 Sep. 6 which is hereby incorporated herein by reference its entirety.

### 1. FIELD OF THE INVENTION

The present invention is a liquid level detecting system and method thereof, more particularly, a system and method thereof for detecting liquid level through image identification.

### 2. DESCRIPTION OF THE PRIOR ART

In order to detect the liquid level in a container, the liquid level detecting scheme utilized by traditional art includes ultrasonic detecting scheme, radar detecting scheme and image identification detecting scheme.

The ultrasonic detecting scheme and radar detecting scheme are conducted to acquire the inner current liquid level by setting up an ultrasonic device and radar device over the container opening and analyzing the echo signal. However, when the size of container is small enough (e.g. tubular size) to be limited by the physical size of the ultrasonic device and radar device and the resolution, the aforementioned scheme will not be able to detect the liquid level in the container with such size.

Traditional art further employs image identification scheme to detect liquid level, technical disclosed in applications such as TW-200636216, Image water level measurement device and method, I396832, An identification method for liquid level, acquires the tested level and label image and then identifies the image to determine the level value of tested liquid. But for aforementioned art, since it is relatively difficult for image identification of transparent liquid and identification of the scale label on transparent container (e.g. transparent tube) when the filling container is a transparent container and the tested liquid is a transparent liquid (e.g. water, alcohol etc.), the traditional art will thus be unable to detect the liquid level in aforementioned container.

In summary, the technical problem to be solved by the field is how to provide a technical scheme for addressing the above-mentioned problems.

### SUMMARY OF THE INVENTION

To solve the problem disclosed previously, the purpose of the present invention is to provide a detecting scheme for liquid level by image identification.

To achieve above purpose, the present invention proposes a liquid level detecting system. Aforementioned system comprises a transparent container, a labeling element, a image acquiring device and an electronic device. Aforementioned transparent container is used to contain tested liquid, and the labeling element is neighbored to the transparent container. And the transparent container and the labeling element are located in a shooting range of the image acquiring device. The electronic device is electrically connected with the image acquiring device, wherein the electronic device enables the image acquiring device to acquire an image of the transparent container and the labeling element and analyzes an image portion affected by tested liquid so as to determines a liquid level of tested liquid.

To achieve above purpose, the present invention provides a method of detecting liquid level. Aforementioned method, applied in an electronic device, comprises the following steps: First, acquiring an image which includes a labeling element used to fill a transparent container of tested liquid and neighbored to the transparent container. Then, analyzing an image portion affected by tested liquid in the image so as to determine a liquid level of tested liquid.

In conclusion, the liquid level detecting system and method thereof of the present invention can effectively determine the liquid level in a transparent container through analyzing the image portion of the labeling element affected by the tested liquid, thereby compensating for the lack of the prior art.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a system view of liquid level detecting system, according to the first embodiment of the present invention.

FIG. 2 is a flow chart of liquid level detecting system, according to the second embodiment of the present invention.

FIG. 3 is an operation flow chart of liquid level detecting system, according to the first embodiment of the present invention.

FIG. 4 is an image acquired by the transparent container, according to the first embodiment of the present invention.

FIG. 5 is a distribution view of pixel blocks in the transparent container, according to the first embodiment of the present invention.

FIG. 6 is a configuration view of the pixel dots in the pixel blocks, according to the first embodiment of the present invention.

FIG. 7 is a image of the transparent container with completely empty contents, according to the first embodiment of the present invention.

FIG. 8 is a image of the transparent container with full contents, according to the first embodiment of the present invention.

### DETAILED DESCRIPTION OF THE PREFERRED EMBODIMENT

The following description is about embodiments of the present invention; however it is not intended to limit the scope of the present invention.

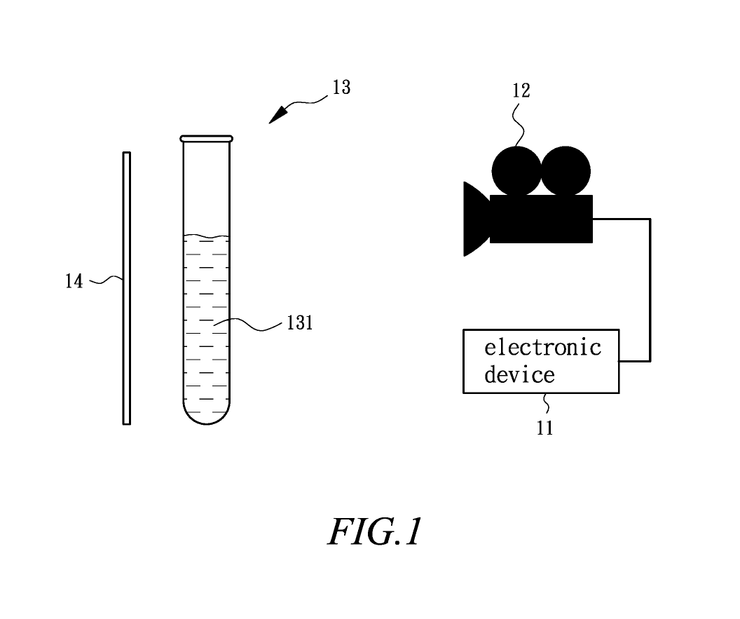

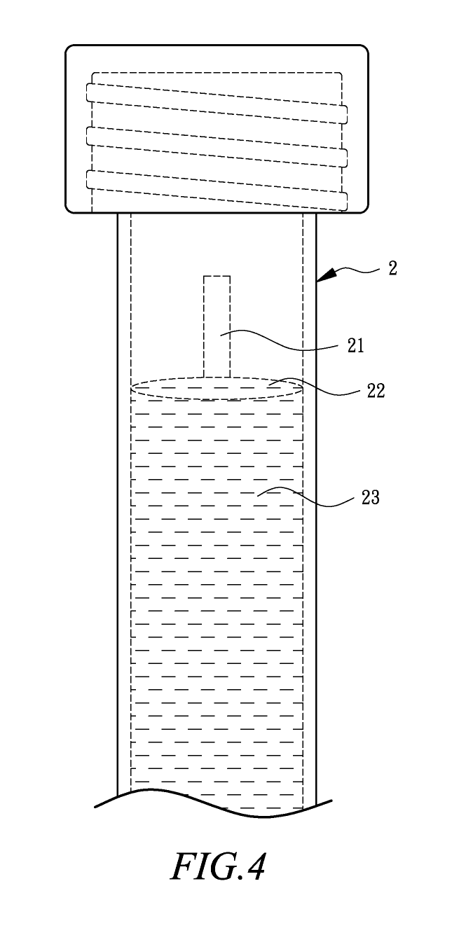

With reference to FIG. 1, a system view of liquid level detecting system 1, according to the first embodiment of the present invention, is shown. Aforementioned liquid level detecting system 1 comprises an electronic device 11 with computing capability, an image acquiring device 12, a transparent container 13 and a labeling element 14. Aforementioned transparent container 13 and labeling element 14 are located in a shooting range of the image acquiring device 12. Aforementioned electronic device 11 is electrically connected with the image acquiring device 12 and commands the image acquiring device 12 to acquire an image 2 (shown in FIG. 4) of the transparent container 13 and the labeling element 14; after the image acquired by the electronic device 11, it may analyze an image portion affected of the labeling element 14 by tested liquid 131 so as to determines a liquid level of tested liquid 131.

Aforementioned electronic device 11 may be a device capable processing images such as computer, smart mobile communication device, embedded system circuit module etc. Aforementioned image acquiring device 12 is a device capable of acquiring images such as video camera, camera, camera compact module etc.

Aforementioned labeling element 14 may be an object capable of being identified by computer image process such as light source device, straight stripe object, oblique stripe object etc. And the labeling element 14 is located adjacent to the transparent container 13, wherein the distance is sufficient to map the image of the labeling element 14 onto the tested liquid 131 in the transparent container 13. In another embodiment, the transparent container 13 is positioned between the image acquiring device 12 and the labeling element 14 such that the image of the transparent container 13 and the image of the labeling element 14 covering the image of the transparent container 13 can be simultaneously acquired when the image acquiring device 12 is shooting toward the transparent container 13. And when the transparent container 13 is filled with the tested liquid 131, the image of labeling element 14 corresponding to the liquid 131 may affected by the liquid to amplify, thus the present invention determines the liquid level through identifying whether the image of the labeling element 14 is amplified by the liquid or not.

In another embodiment, aforementioned electronic device 11 finds a first image portion 21 (shown in FIG. 4) of the labeling element 14 affected by the tested liquid 131 in the image, and finds a second image portion 23 (shown in FIG. 4) of the labeling element 14 without being affected by the tested liquid 131 in the image, and then determines the liquid level of the tested liquid 131 according to a joint portion 22 (shown in FIG. 4) between the first image portion 21 and the second image portion 23.

In another embodiment, the electronic device 11 configures vertical pixels of a transparent container 13 image into a plurality of blocks and determines the liquid level of the tested liquid 131 according to a pixel difference between the neighbored blocks.

In another embodiment, the electronic device 11 analyzes pixel values of an image neighbored to the end of the transparent container 13 in the image so as to determine the transparent container 13 is full or full empty.

In another embodiment, the electronic device 11 executes a blur processing to the image, then analyzes the image portion of the labeling element 14 affected by the tested liquid 131 to determine the liquid level of the tested liquid 131.

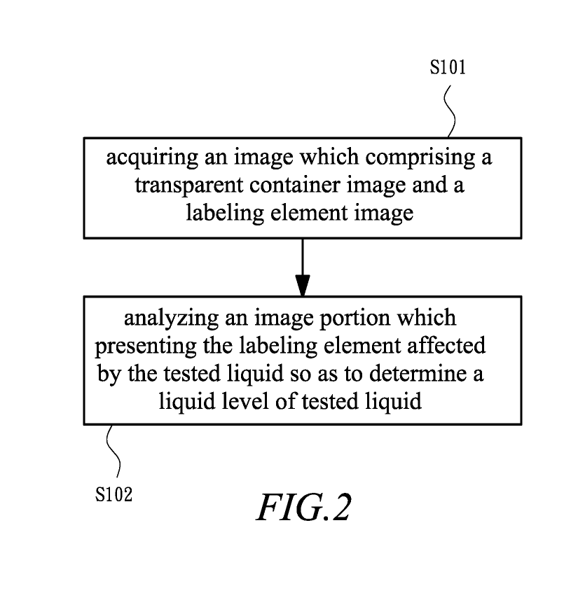

With reference to FIG. 2, a flow chart of liquid level detecting system, according to the second embodiment of the present invention, is shown. The method, applied and executed in an electronic device with computing capability, contains the following steps:

S101: Acquiring an image which includes a label element used to fill a transparent container of tested liquid and neighbored to the transparent container.

S102: Analyzing an image portion of the labeling element affected by the tested liquid in the image to determine the liquid level of the tested liquid.

In another embodiment, aforementioned method further searches a first image portion of the labeling element affected by the tested liquid and searches a second image portion of the labeling element without being affected by the tested liquid, then determines the liquid level of the tested liquid according to a joint portion between the first image portion and the second image portion.

In another embodiment, aforementioned method configures vertical pixels of a transparent container image into a plurality of blocks and determines the liquid level of the tested liquid according to a pixel difference between the neighbored blocks.

In another embodiment, aforementioned method further analyzes pixel values of an image neighbored to the end of the transparent container in the image so as to determine the transparent container is full or full empty.

In another embodiment, aforementioned method further executes a blur processing to the image, then analyzes the image portion of the labeling element affected by the tested liquid to determine the liquid level of tested liquid.

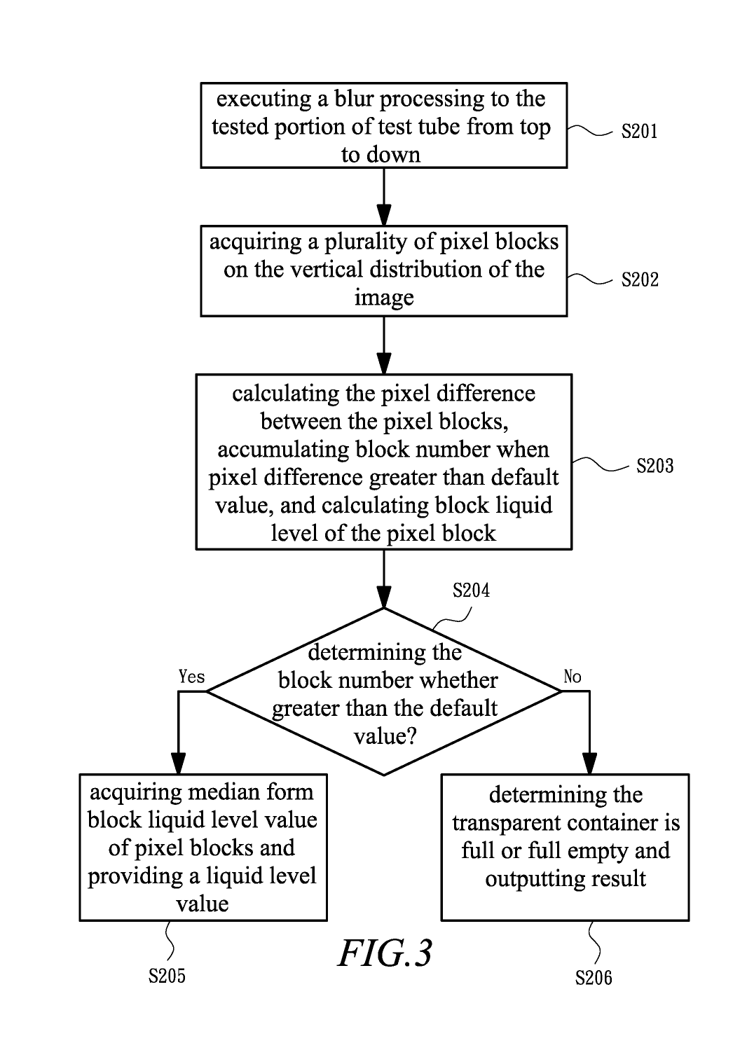

The following are descriptions for the system of liquid level detecting system 1 according to the first embodiment of the present invention, and the method for detecting liquid level according to the second embodiment of the present invention can also achieve the same or similar technical effects. Aforementioned liquid level detecting system 1 can also be applied to detect the liquid level of the liquid in a tube. With reference to FIG. 3, an operation flow chart of liquid level detecting system 1, according to the first embodiment of the present invention, is shown as below:

S201: Executing a blur process for the tested part from the top of the tube to the bottom. In this step, with respect to the scale imprinted on the wall of part of the transparent container 13 and in order to prevent the scale image from affecting the image determination procedure, the electronic device 11 executes the blue process after an image 2 is acquired, and obtains the acquired image 2 of the transparent container 13 as shown in FIG. 4. In the present embodiment, the labeling element 14 is a lamp tube.

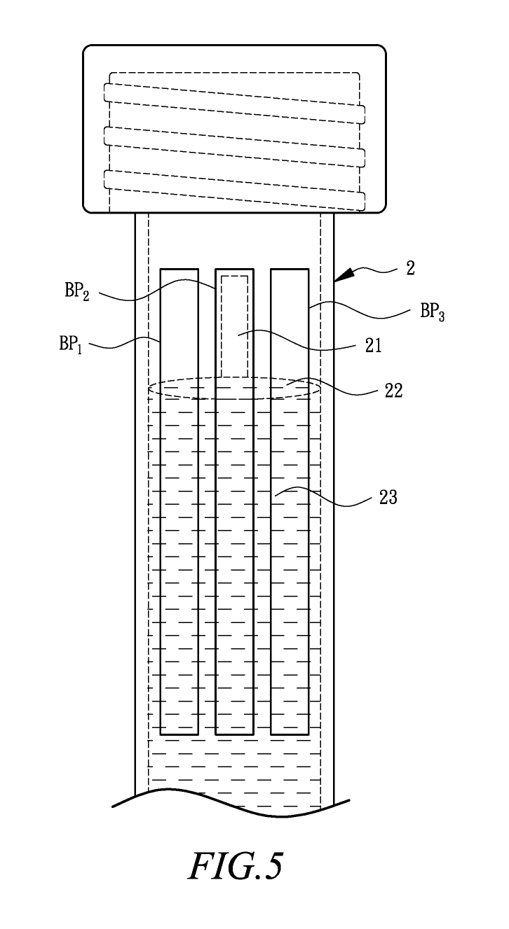

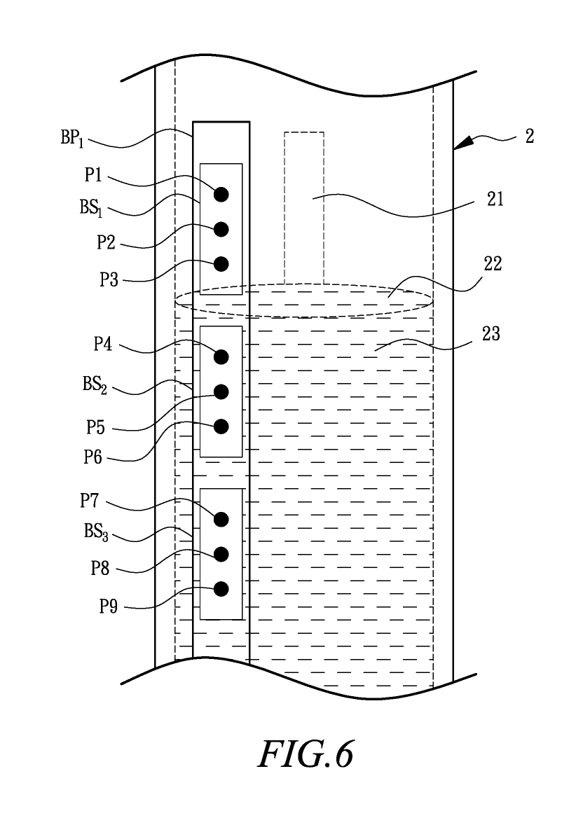

S202: Acquiring a plurality of vertically-distributed pixel blocks from the image. With reference to FIG. 5, the electronic device 11 now may acquire a plurality of vertically-distributed pixel blocks BP1˜BP3 in a horizontal axial direction of the transparent container 13, wherein a plurality of vertically-distributed pixel dots (FIG. 6) are included in each pixel block.

S203: Calculating the pixel difference between upper and lower pixel in each pixel block, then accumulating the blocks and calculating the block liquid level of this pixel block when the difference is larger than a predefined value. With continuous reference to FIG. 6, BP1 is taken as an example to illustrate, the electronic device 11 then configures the plurality of pixel dots (e.g. P1˜P9) in this block into a plurality of sub-blocks (BS1˜BS3). If the pixel value of the bright spot generated by the lamp tube is 255 and that of the dark spot is 0, the pixel value of each sub-block is aggregated as shown in Table 1:

TABLE 1

| | sub-block | pixel dots contained | pixel value aggregation |
|---|---|---|---|
| 1 | BS1 | P1 \grave{ } P2 \grave{ } P3 | S1 = 0 + 0 + 0 = 0 |
| 2 | BS2 | P4 \grave{ } P5 \grave{ } P6 | S2 = 255 + 255 + 255 = 765 |
| 3 | BS3 | P7 \grave{ } P8 \grave{ } P9 | S3 = 255 + 255 + 255 = 765 |

It can be known from the pixel value of the pixel dots that the sub-block BS2 and BS 3 are the first image portion 21 of the labeling element 14 affected by the tested liquid 131, and the sub-block BS1 is the second image portion 23 of the labeling element 14 without being affected by the tested liquid 131, wherein their joint portion 22 is the liquid level.

Next, the electronic device 11 calculates the difference among the sub-blocks and determines whether the difference meets the brightness difference threshold (e.g. larger than 765); when the difference meets the brightness difference threshold, the neighbored position of current difference blocks is viewed as the liquid level. Seen from descriptions of above case, the neighbored blocks having maximum difference (Diff=|S1−S2|=|0−765|=765) are BS1 and BS2. Therefore P3 and P4 is the liquid level of the pixel block BP1. The electronic device 11 can calculate the liquid level through the distribution positions of the pixel dots in the transparent container 13 or recognize what the value represented by aforementioned pixel dots is through inquiring the data list of internal memory, for example, the liquid level represented by P3 and P4 is recognized as 4 centimetre through the data list established inside.

The liquid level of the pixel bocks BP2˜BP3 is calculated similar to those mentioned above, and the number of blocks is accumulated when the liquid level of each pixel block BP can be calculated. In the present embodiment, the pixel blocks of liquid level can be calculated as BP1 and BP3, and the liquid level cannot be acquired due to the similar or same pixel value (e.g. 255) in BP2, thus now the number of blocks at the liquid level height is 2 (BP1 and BP3).

S204: Determining to find out whether the block number at liquid level height is larger than a threshold? If it is, S205 is executed; if not larger than the threshold, S206 is executed. Aforementioned threshold is used to determine whether the inside of the transparent container 13 is entirely full or empty. In the present embodiment, the threshold is defined as 1 by this case.

S205: Calculating out a median from the liquid level height of each pixel block and generating a liquid level height. If the block number at the current liquid level height is 11 and the liquid level heights of each block are 1 centimetre, 2 centimetre, 3 centimetre, 3 centimetre, 3 centimetre, 3 centimetre, 3 centimetre, 4 centimetre, 4 centimetre, 5 centimetre, 5 centimetre, the median is 3 centimetre.

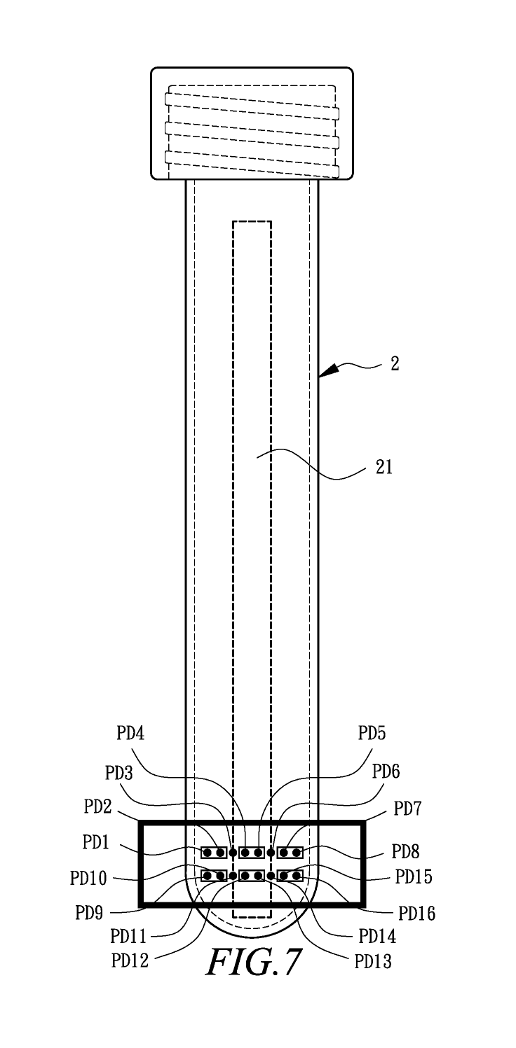

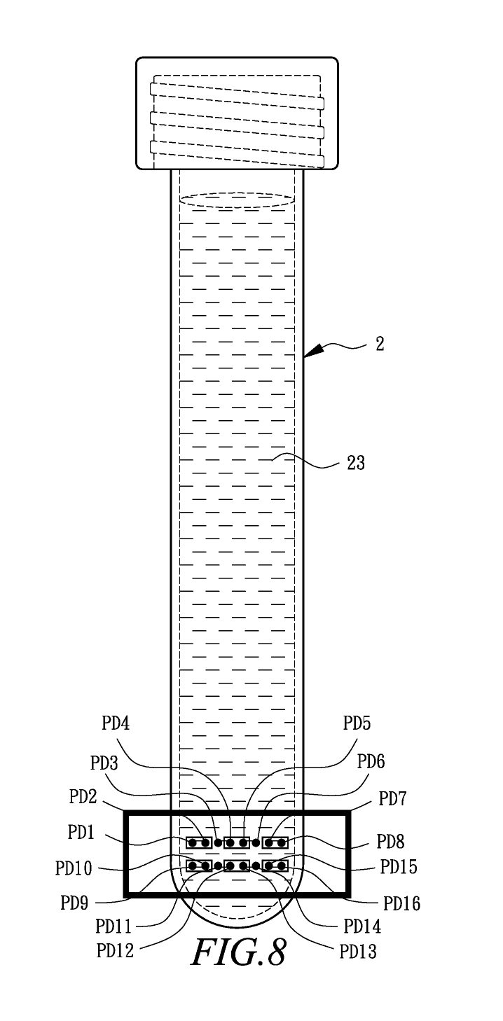

S206: Determining whether the liquid level is entirely full or empty and outputting results. When the block number has not reached the threshold, it refers to that the container is entirely full or empty. With reference to FIGS. 7 and 8, images of the transparent container 13 with completely empty or full contents are respectively shown. In this process, a plurality of horizontal pixel dots (PD1˜PD13) is acquired tranversely from the end of the transparent container 13 in a manner similar to above determination mode for liquid level. This part is used to compare the pixel difference between adjacent horizontal pixel dots for finding out an edge of the first image portion 21.

For example, if there is a maximum difference (Diff=500−0=500) between the aggregation (SUM=0+0=0) of a set of horizontal pixel dots {PD1,PD2} and the aggregation (SUM=255+255=500) of a set of horizontal pixel dots {PD4,PD5}, a horizontal pixel dot PD3 at the edge of the first image portion 21 can be found out. In FIG. 7, after above image process, horizontal pixel dots PD3, PD6, PD11 and PD14 at the edge can be found out to give an indication that there is no liquid at the lower part of the transparent container 13 and the transparent container 13 is determined to be entirely empty; in contrast, when horizontal pixel dots at the edge of the first image portion 21 cannot be found out by the process from the horizontal pixel dots (PD1˜PD13) in the image which is at the end (lower end) of the transparent container 13 away from the side wall thereof, it indicates that the transparent container 13 is entirely full.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A liquid level detecting system, comprising:
a transparent container, configured to contain tested liquid;
a labeling element, neighbored to the transparent container;
an image acquiring device, wherein the transparent container and the labeling element are located in a shooting range of the image acquiring device; and
an electronic device, electrically connected with the image acquiring device, wherein the electronic device enables the image acquiring device to acquire an image of the transparent container and the labeling element and analyzes an image portion affected by tested liquid so as to determines a liquid level of tested liquid.

2. The system as claimed in claim 1, wherein the electronic device searches the image to find a first image portion which presenting the labeling element affected by tested liquid, searches the image to find a second image portion which presenting the labeling element without affected by tested liquid, and determines the liquid level according to a joint portion between the first image portion and the second image portion.

3. The system as claimed in claim 1, wherein the electronic device configures vertical pixels of a transparent container image of the image into a plurality of blocks and determines the liquid level according to a pixel difference between the neighbored blocks.

4. The system as claimed in claim 2, wherein the electronic device configures vertical pixels of a transparent container image of the image into a plurality of blocks and determines the liquid level according to a pixel difference between the neighbored blocks.

5. The system as claimed in claim 1, wherein the electronic device analyzes pixel values of an ending image of a transparent container image of the image so as to determine the transparent container is full or full empty.

6. The system as claimed in claim 2, wherein the electronic device analyzes pixel values of an ending image of the transparent container image of the image so as to determine the transparent container is full or full empty.

7. The system as claimed in claim 1, wherein the electronic device executes a blur processing to the image, then analyzes the image portion affected by tested liquid, and determines the liquid level of tested liquid.

8. The system as claimed in claim 2, wherein the electronic device executes a blur processing to the image, then analyzes the image portion affected by tested liquid, and determines the liquid level of tested liquid.

9. A method of detecting liquid level, applied in an electronic device, comprising:
enabling the electronic device to acquire an image which recording a transparent container and a labeling element, wherein the transparent container is used to fill tested liquid and the labeling element is neighbored to the transparent container; and
enabling the electronic device to analyze an image portion affected by test liquid in the image so as to determine a liquid level of tested liquid.

10. The method as claimed in claim 9, further enabling the electronic device to search the image to find a first image portion which presenting the labeling element affected by tested liquid, search the image to find a second image portion which presenting the labeling element without affected by tested liquid, and determine the liquid level according to a joint portion between the first image portion and the second image portion.

11. The method as claimed in claim 9, further enabling the electronic device to configure vertical pixels of a transparent container image of the image into a plurality of blocks and determine the liquid level according to a pixel difference between the neighbored blocks.

12. The method as claimed in claim 10, further enabling the electronic device to configure vertical pixels of a transparent container image of the image into a plurality of blocks and determine the liquid level according to a pixel difference between the neighbored blocks.

13. The method as claimed in claim 9, further enabling the electronic device to analyze pixel values of an ending image of a transparent container image of the image so as to determine the transparent container is full or full empty.

14. The method as claimed in claim 10, further enabling the electronic device to analyze pixel values of an ending image of the transparent container image of the image so as to determine the transparent container is full or full empty.

15. The method as claimed in claim 9, further enabling the electronic device to execute a blur processing to the image, then analyze the image portion affected by tested liquid, and determine the liquid level of tested liquid.

16. The method as claimed in claim 10, further enabling the electronic device to execute a blur processing to the image, then analyze the image portion affected by tested liquid, and determine the liquid level of tested liquid.
